(19) United States
(12) Patent Application Publication
(10) Pub. No.: US 2020/0074851 A1
(43) Pub. Date: Mar. 5, 2020

(54) CONTROL DEVICE AND CONTROL METHOD

(71) Applicant: HONDA MOTOR CO., LTD., MINATO-KU, TOKYO (JP)

(72) Inventors: Takuyuki MUKAI, WAKO-SHI, SAITAMA-KEN (JP); Jun TANAKA, WAKO-SHI, SAITAMA-KEN (JP); Ken HANAYAMA, WAKO-SHI, SAITAMA-KEN (JP); Jun IBUKA, WAKO-SHI, SAITAMA-KEN (JP); Hiroaki HORII, WAKO-SHI, SAITAMA-KEN (JP); Jun OCHIDA, WAKO-SHI, SAITAMA-KEN (JP)

(21) Appl. No.: 16/467,302

(22) PCT Filed: Dec. 7, 2016
(86) PCT No.: PCT/JP2016/086397

§ 371 Date: Jun. 6, 2019

(51) Int. Cl. G08G 1/01; B60W 30/18; B60W 50/14

(52) U.S. Cl. CPC G08G 1/0125; B60W 30/18; B60W 2050/0072; B60W 2050/143; B60W 50/14

(57) ABSTRACT

A traffic signal recognition unit recognizes a traffic signal of a traffic signal machine to be next followed on the basis of outside information. A traffic participant recognition unit recognizes the motion of a traffic participant on the basis of the outside information. A prediction unit predicts a traffic signal to be followed next on the basis of the motion of traffic participant recognized by the traffic participant recognition unit. A comparison unit compares the traffic signal recognized by the traffic signal recognition unit with the traffic signal predicted by the prediction unit. An action planning unit makes an action plan of a host vehicle on the basis of the comparison result of the comparison unit. A control unit carries out prescribed control on the basis of the action plan.

### TECHNICAL FIELD

The present invention relates to a control device and a control method for performing prescribed control of a host vehicle using external environment information acquired by an external environment sensor.

### BACKGROUND ART

Japanese Laid-Open Patent Publication No. 2009-015759 discloses a device for judging the color of a signal light based on an image of a traffic signal device captured by a camera. The light of a traffic signal device formed by an LED blinks when viewed microscopically. The objective of the device of Japanese Laid-Open Patent Publication No. 2009-015759 is to correctly recognize the color of the signal light, while assigning low reliability to images captured immediately after the LED lights up or immediately before the LED turns off. Specifically, this device selects signal light candidate information that includes the greatest brightness information among a plurality of pieces of signal light candidate information obtained in the recent past, and judges the color of the signal light (traffic signal) based on the color information of the selected signal light candidate information.

### Summary of Invention

When capturing an image of a traffic signal device with a camera, if the image capturing environment is poor due to flashback, poor weather, or the like, it becomes difficult to identify the color compared to when the image capturing environment is good, and there is a concern that the traffic signal would be misidentified. Furthermore, there are cases where misidentification of a traffic signal occurs due to a malfunction of the signal recognition function. There is a desire to be able to suitably perform vehicle control in a case where the recognition system in the vehicle misidentifies a traffic signal.

The present invention has been devised in order to solve this type of problem, and has the object of providing a control device and a control method that are able to restrict vehicle control based on misidentification of a traffic signal.

The present invention is a control device that performs prescribed control of a host vehicle using external environment information acquired by an external environment sensor, and the control device includes a traffic signal recognition unit configured to recognizes a traffic signal of a traffic signal device to be obeyed next, based on the external environment information; a traffic participant recognition unit configured to recognize movement of a traffic participant, based on the external environment information; an estimating unit configured to estimate the traffic signal to be obeyed next, based on the movement of the traffic participant recognized by the traffic participant recognition unit; a comparing unit configured to compare the traffic signal recognized by the traffic signal recognition unit to the traffic signal estimated by the estimating unit; and a control unit configured to perform the control based on a comparison result of the comparing unit. According to the above configuration, even when misidentification of a traffic signal occurs, it is possible to prevent control based on this misidentification, by performing prescribed control using the result of the comparison between the recognized traffic signal and the estimated traffic signal.

The estimating unit may estimate the traffic signal based on the movement of another vehicle travelling in a travel lane in which the host vehicle is travelling or in another lane that has the same progression direction as the travel lane. Specifically, if the traffic participant recognition unit recognizes that the other vehicle has stopped in front of the traffic signal device, the estimating unit may estimate that the traffic signal is a stop instruction signal. According to the above configuration, it is possible to accurately estimate the traffic signal, by estimating the signal shown by the traffic signal device based on the movement of the other vehicles that obey the same signal as the traffic signal to be obeyed by the host vehicle.

If the traffic participant recognition unit recognizes a traffic participant that is crossing in front of the host vehicle, the estimating unit may estimate that the traffic signal is a stop instruction signal. According to the above configuration, it is possible to accurately estimate the traffic signal, by estimating the signal shown by the traffic signal device based on the movement of the other vehicles that obey a different signal than the traffic signal to be obeyed by the host vehicle.

If the traffic participant recognition unit recognizes that another vehicle located in an opposing lane that opposes the travel lane in which the host vehicle is travelling has stopped at a stop position of the traffic signal device, the estimating unit may estimate that the traffic signal is a stop instruction signal. According to the above configuration, it is possible to accurately estimate the traffic signal, by estimating the signal shown by the traffic signal device based on the movement of the other vehicles that obey the same signal as the traffic signal to be obeyed by the host vehicle.

If the traffic signal recognized by the traffic signal recognition unit differs from the traffic signal estimated by the estimating unit, the control unit may make a request for manual driving to a driver. With the above configuration, it is possible for the driver to take over the driving when the device cannot determine which of the recognized traffic signal and the estimated traffic signal is correct.

If the traffic signal recognized by the traffic signal recognition unit differs from the traffic signal estimated by the estimating unit, the control unit may decelerate or stop the host vehicle. With the above configuration, it is possible to suitably control the host vehicle even if the driver cannot take over the driving.

If the traffic signal recognized by the traffic signal recognition unit differs from the traffic signal estimated by the estimating unit, the control unit may provide a warning to a driver. With the above configuration, it is possible to notify the driver that the device cannot determine which of the recognized traffic signal and the estimated traffic signal is correct.

The present invention is a control method for performing prescribed control of a host vehicle using external environment information acquired by an external environment sensor, and the control method includes a traffic signal recognizing step of recognizing a traffic signal of a traffic signal device to be obeyed next, based on the external environment information; a traffic participant recognizing step of recognizing movement of a traffic participant, based on the external environment information; an estimating step of estimating the traffic signal to be obeyed next, based on the movement of the traffic participant recognized in the traffic participant recognizing step; a comparing step of comparing the traffic signal recognized in the traffic signal recognizing step to the traffic signal estimated in the estimating step; and a control step of performing the control based on a comparison result of the comparing step. According to the above method, even when misidentification of a traffic signal occurs, it is possible to prevent control based on this misidentification, since prescribed control is performed using the result of the comparison between the recognized traffic signal and the estimated traffic signal.

### BRIEF DESCRIPTION OF DRAWINGS

FIG. 1 is a block diagram showing a configuration of the vehicle control system including the control device according to the present invention;

FIG. 2 is a flow chart of the main process performed by the control device according to a first embodiment;

FIG. 3 is a flow chart of the signal estimation process performed by the control device;

FIG. 4 is a diagram for describing the situation in which the process of step S21 of FIG. 3 is performed;

FIG. 5 is a diagram for describing the situation in which the process of step S21 of FIG. 3 is performed;

FIG. 6 is a diagram for describing the situation in which the process of step S22 of FIG. 3 is performed;

FIG. 7 is a diagram for describing the situation in which the process of step S23 of FIG. 3 is performed; and

FIG. 8 is a flow chart of the main process performed by the control device according to a second embodiment.

### DESCRIPTION OF EMBODIMENTS

The following describes examples of preferred embodiments of a control device and a control method according to the present invention, with reference to the accompanying drawings.

### 1. Configuration of the Vehicle Control System 10

A control device 20 according to the present invention forms a portion of a vehicle control system 10 mounted in a vehicle. The following describes the vehicle control system 10, as well as the control device 20 and the control method.

[1.1. Overall Configuration]

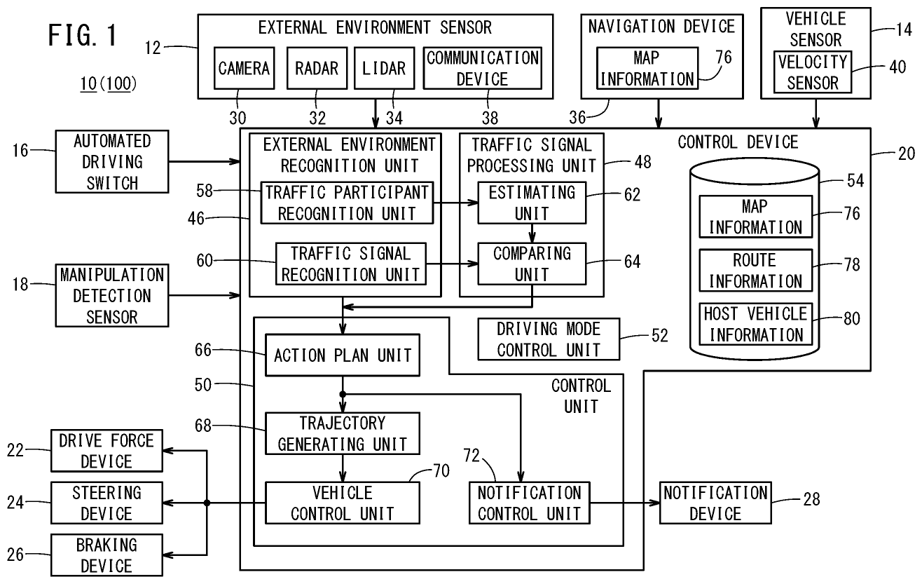

The vehicle control system 10 is described using FIG. 1. The vehicle control system 10 is incorporated in a vehicle 100 (also referred to below as a “host vehicle 100”), and performs travel control of the vehicle 100 using automated driving. This “automated driving” has a scope including not only “fully automated driving” where all travel control of the vehicle 100 is automated, but also “partial automated driving” and “assisted driving” where the travel control is partially automated.

The vehicle control system 10 is basically formed by an input system device group, the control device 20, and an output system device group. The devices forming the input system device group and the output system device group are each connected to the control device 20 via a communication line.

The input system device group includes an external environment sensor 12, a vehicle sensor 14, an automated driving switch 16, and a manipulation detection sensor 18. The output system device group includes a drive force device 22 that drives the wheels (not shown in the drawings), a steering device 24 that steers the wheels, a braking device 26 that brakes the wheels, and a notification device 28 that provides notification to a driver mainly through visual, audio, or tactile means.

[1.2. Detailed Configuration of the Input System Device Group]

The external environment sensor 12 acquires information (referred to below as external environment information) indicating the state outside the vehicle 100, and outputs this external environment information to the control device 20. Specifically, the external environment sensor 12 is configured to include one or more cameras 30, one or more radars 32, one or more LIDARs 34 (Light Detection and Ranging, Laser imaging Detection and Ranging), and a communication device 38.

A navigation device 36 is configured to include a position measurement device that measures a position of the vehicle 100 using a satellite or the like, a storage device that stores map information 76, and a user interface (e.g., a touch-panel display, a speaker, and a microphone). The navigation device 36 generates a travel route from the position of the vehicle 100 to a destination designated by a user, using the position measurement device and the map information 76. The position information of the vehicle 100 and the information concerning the travel route are output to the control device 20.

The communication device 38 is configured to communicate with external devices, including roadside devices, other vehicles, and servers, and sends and receives information concerning traffic devices (traffic signals and the like), information concerning other vehicles, probe information, and the newest map information 76. Various information is output to the control device 20.

The vehicle sensor 14 includes a velocity sensor 40 that detects the vehicle velocity Vo (vehicle speed). The vehicle sensor 14 includes various sensors not shown in the drawings, e.g. an acceleration sensor that detects acceleration, a lateral G sensor that detects lateral G, a yaw rate sensor that detects angular acceleration around a vertical axis, an orientation sensor that detects orientation and direction, and a gradient sensor that detects a gradient. Signals detected by the respective sensors are output to the control device 20.

The automated driving switch 16 is a switch provided to the steering wheel, the instrument panel, or the like. The automated driving switch 16 is configured to switch between a plurality of driving modes, by being manually manipulated by a user including the driver. The automated driving switch 16 outputs a mode switching signal to the control device 20.

The manipulation detection sensor 18 detects the presence of a manipulation, the manipulation amount, the manipulation position, and the like made by the driver on each manipulation device (not shown in the drawings). The manipulation detection sensor 18 includes an acceleration pedal sensor that detects a manipulation amount and the like of an acceleration pedal, a brake pedal sensor that detects a manipulation amount and the like of a brake pedal, a torque sensor that detects steering torque input by the steering wheel, and a direction indicator sensor that detects the manipulation direction of a direction indicator switch. The signals detected by these sensors are output to the control device 20.

[1.3. Detailed Configuration of the Output System Device Group]

The drive force device 22 is formed from a drive force ECU (Electronic Control Unit) and a drive source including an engine/drive motor. The drive force device 22 generates a travel drive force (torque) for the vehicle 100 according to a vehicle control value output from the control device 20, and transmits this travel drive force to the wheels either directly or via a transmission.

The steering device 24 is formed from an EPS (Electric Power Steering System) ECU and an EPS actuator. The steering device 24 changes the orientation of the wheels (steered wheels) according to a vehicle control value output from the control device 20.

The braking device 26 is an electric servo brake that is used in combination with a hydraulic brake, and is formed from a brake ECU and a brake actuator. The braking device 26 brakes the wheels according to a vehicle control value output from the control device 20.

The notification device 28 is formed from a notification ECU, a display device, an audio device, and a tactile device. The notification device 28 performs a notification operation concerning automated driving or manual driving, according to notification instructions output from the control device 20.

[1.4. Driving Modes]

The control device 20 is set to switch between an “automated driving mode” and a “manual driving mode” (non-automated driving mode), according to a manipulation of the automated driving switch 16. The automated driving mode is a driving mode in which the vehicle 100 travels under the control of the control device 20, in a state where the manipulation devices (specifically the acceleration pedal, steering wheel, and brake pedal) are not manipulated by the driver. In other words, the automated driving mode is a driving mode in which the control device 20 controls some or all of the drive force device 22, the steering device 24, and the braking device 26 according to an action plan that is consecutively created. When the driver performs a prescribed manipulation using a manipulation device while in the automated driving mode, the automated driving mode is automatically cancelled and switched to a driving mode (including the manual driving mode) with a relatively lower level of driving automation.

[1.5. Configuration of the Control Device 20]

The control device 20 is formed by one or more ECUs, and includes a storage device 54 and various function realizing units. The function realizing units are software function unit in which functions are realized by a CPU (Central Processing Unit) executing programs stored in the storage device 54. The function realizing units can also be realized by hardware function units made from an integrated circuit such as an FPGA (Field-Programmable Gate Array) or the like. The function realizing units include an external environment recognition unit 46, a traffic signal processing unit 48, a control unit 50, and a driving mode control unit 52.

The external environment recognition unit 46 recognizes static external environment information around the vehicle 100 to generate external environment recognition information, using the external environment information acquired by the external environment sensor 12, the map information 76 stored in the storage device 54, and the like. The static external environment information includes recognition targets, such as lane marks, stop lines, traffic signals, traffic signs, geographic features (real estate), travelable regions, evacuation regions, and the like, for example. Furthermore, the static external environment information also includes position information of each recognition target. The external environment recognition unit 46 uses the external environment information acquired by the external environment sensor 12 to recognize dynamic external environment information around the vehicle 100 and generate the external environment recognition information. The dynamic external environment information includes obstacles such as stopped vehicles, traffic participants such as pedestrians and other vehicles (including bicycles), traffic signals (the colors shown by traffic signal devices), and the like. Furthermore, the dynamic external environment information also includes information concerning the movement direction of each recognition target.

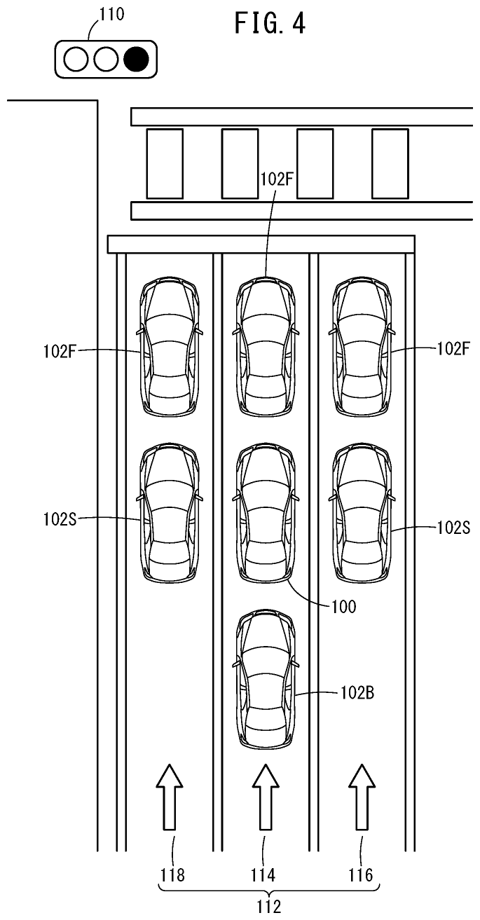

Among the functions of the external environment recognition unit 46, a traffic participant recognition unit 58 performs the function of recognizing traffic participants based on the external environment information, and a traffic signal recognition unit 60 performs the function of recognizing the signal of a traffic signal device 110 (see FIG. 4 and the like) to be obeyed next, based on the external environment information. The traffic participant recognition unit 58 recognizes the presence of a traffic participant, the position of the traffic participant, and the movement direction of the traffic participant using at least one of the image information of the camera 30, a detection result of the radar 32, and a detection result of the LIDAR 34. For example, the traffic participant recognition unit 58 can recognize the movement direction of a recognition target by estimating the optical flow of an entire image based on the image information of the camera 30. Furthermore, the traffic participant recognition unit 58 can recognize the movement direction of a recognition target by calculating the relative speed of the recognition target with respect to the vehicle 100, based on the detection results of the radar 32 or LIDAR 34. Yet further, the traffic participant recognition unit 58 can recognize the movement state and movement direction of the recognition target by performing vehicle-to-vehicle communication or road-to-vehicle communication with the communication device 38. The traffic signal recognition unit 60 recognizes the presence of a traffic signal device 110, the position of the traffic signal device 110, and the traffic signal shown by the traffic signal device 110 using at least one of the image information of the camera 30, traffic information received by the communication device 38, and the map information 76.

The traffic signal processing unit 48 obtains information for determining the reliability of the traffic signal recognized by the traffic signal recognition unit 60. Specifically, the traffic signal processing unit 48 functions as an estimating unit 62 and a comparing unit 64. The estimating unit 62 estimates the traffic signal that is to be obeyed next, based on the movement of the traffic participant recognized by the traffic participant recognition unit 58. The comparing unit 64 compares the traffic signal recognized by the traffic signal recognition unit 60 to the traffic signal estimated by the estimating unit 62. The comparison result of the comparing unit 64 is transmitted to an action plan unit 66. The comparison result is information for determining the reliability of the traffic signal.

The control unit 50 performs travel control and notification control of the vehicle 100, based on the recognition results of the external environment recognition unit 46 and the comparison result of the comparing unit 64. Specifically, the control unit 50 functions as the action plan unit 66, a trajectory generating unit 68, a vehicle control unit 70, and a notification control unit 72.

The action plan unit 66 creates an action plan (time series of events) for each travel segment, based on the recognition results of the external environment recognition unit 46 and the comparison result of the comparing unit 64, and updates the action plan as necessary. Examples of the types of events include deceleration, acceleration, branching, merging, staying in a lane, changing lanes, and overtaking. Here, “deceleration” and “acceleration” are events of decelerating or accelerating the vehicle 100. “Branching” and “merging” are events of causing the vehicle 100 to travel smoothly at a branching point or a merging point. “Changing lanes” is an event of changing the lane in which the vehicle 100 is travelling. “Overtaking” is an event of overtaking another vehicle that is travelling in front of the vehicle 100. “Staying in the lane” is an event of causing the vehicle 100 to travel without deviating from the travel lane, and is further classified in combination with the travel state. Specific travel states include travel at a constant velocity, overtaking travel, decelerating travel, curving travel, or obstacle-avoiding travel. Furthermore, the action plan unit 66 transmits notification instructions to the notification control unit 72, to request manual driving, provide a warning, or the like to the driver.

The trajectory generating unit 68 generates a scheduled travel trajectory in accordance with the action plan created by the action plan unit 66, using the map information 76, route information 78, and host vehicle information 80 read from the storage device 54. The scheduled travel trajectory is data indicating target behaviors in time series, and specifically is a time-series data set in which the data units are position, orientation angle, velocity, acceleration/deceleration, curvature, yaw rate, steering angle, and lateral G.

The vehicle control unit 70 determines each vehicle control value for performing travel control of the vehicle 100, according to the scheduled travel trajectory generated by the trajectory generating unit 68. The vehicle control unit 70 outputs the determined vehicle control values to the drive force device 22, the steering device 24, and the braking device 26.

The notification control unit 72 outputs the notification instructions to the notification device 28 in a case where a transition process from the automated driving mode to the manual driving mode is performed by the driving mode control unit 52, or in a case where notification instructions are received from the action plan unit 66.

The driving mode control unit 52 performs a transition process from the manual driving mode to the automated driving mode or a transition process from the automated driving mode to the manual driving mode in response to a signal output from the automated driving switch 16. Furthermore, the driving mode control unit 52 performs the transition process from the automated driving mode to the manual driving mode in response to a signal output from the manipulation detection sensor 18.

The storage device 54 stores the map information 76, the route information 78, and the host vehicle information 80. The map information 76 is information output from the navigation device 36 or the communication device 38. The route information 78 is information concerning a scheduled travel route output from the navigation device 36. The host vehicle information 80 is a detection value output from the vehicle sensor 14. The storage device 54 also stores various numerical values used by the control device 20.

### 2. Process Performed by the Control Device 20 According to the First Embodiment

[2.1. Main Process]

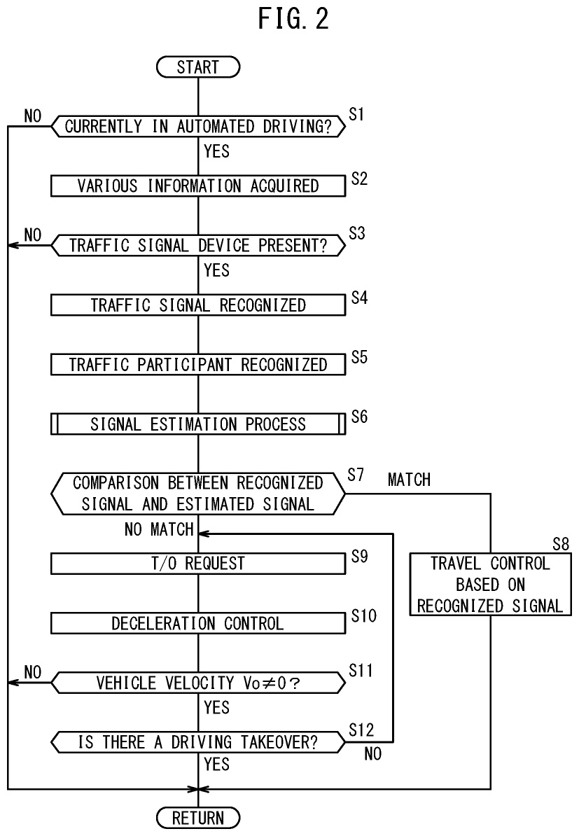

The following describes the main process performed by the control device 20, using FIG. 2. The process described below is performed periodically. At step S1, a determination is made concerning whether automated driving is currently being performed. If automated driving is currently being performed (step S1: YES), the process moves to step S2. On the other hand, if automated driving is not currently being performed (step S1: NO), the process ends for now. At step S2, various types of information are acquired. The control device 20 acquires the external environment information from the external environment sensor 12, and acquires the various signals from the vehicle sensor 14.

At step S3, the traffic signal recognition unit 60 determines whether a traffic signal device 110 is present. The traffic signal recognition unit 60 recognizes the presence of the traffic signal device 110 at a timing when the contour of the traffic signal device 110 is recognized in the image information of the camera 30. Alternatively, the traffic signal recognition unit 60 recognizes the presence of the traffic signal device 110 at a timing when the distance from the vehicle 100 to the traffic signal device 110 has been recognized as being less than or equal to a prescribed distance, using the traffic information or the map information 76 received by the communication device 38. If the traffic signal device 110 is present (step S3: YES), the process moves to step S4. On the other hand, if a traffic signal device 110 is not present (step S3: NO), the process ends for now.

At step S4, the traffic signal recognition unit 60 performs an image recognition process based on the image information of the camera 30 and recognizes the color or lighted position of the traffic signal device 110, thereby recognizing the traffic signal. Alternatively, the traffic signal recognition unit 60 recognizes the traffic signal based on the traffic information received by the communication device 38.

At step S5, the traffic participant recognition unit 58 performs an image recognition process based on the image information of the camera 30, to recognize the traffic participants and nearby lane information. Furthermore, the traffic participant recognition unit 58 recognizes the traffic participants using the detection results of the radar 32 and the detection results of the LIDAR 34. At this time, the traffic participant recognition unit 58 also recognizes the position and movement direction of each traffic participant.

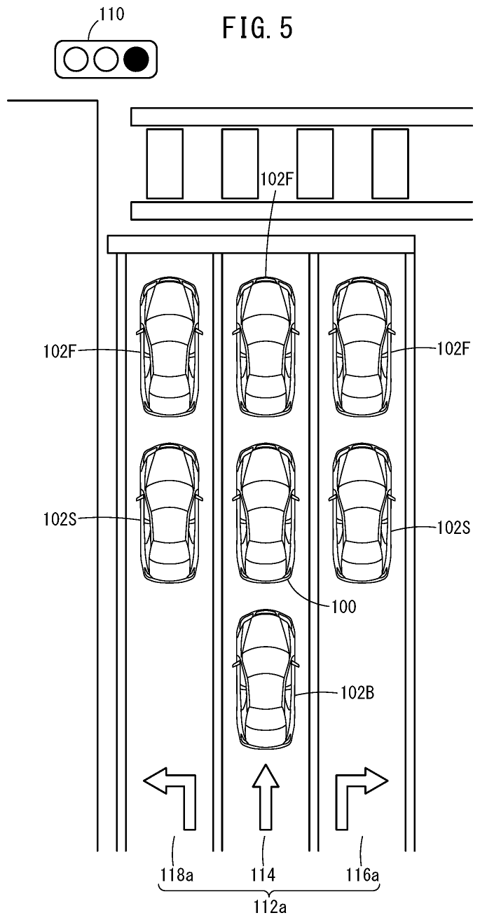

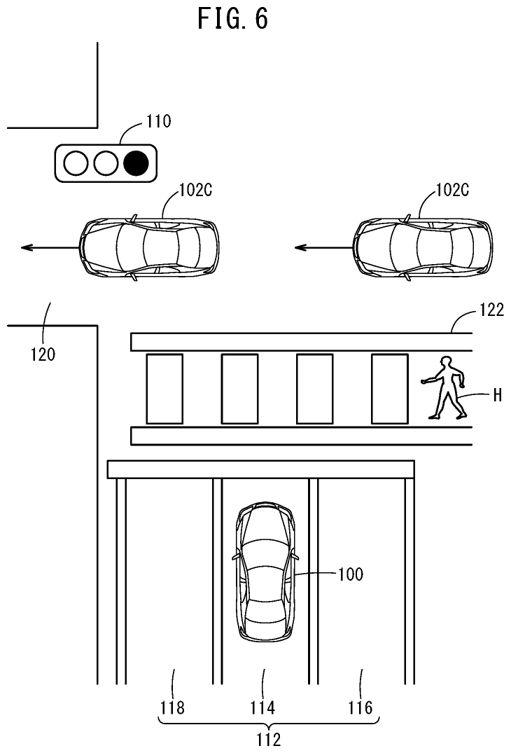

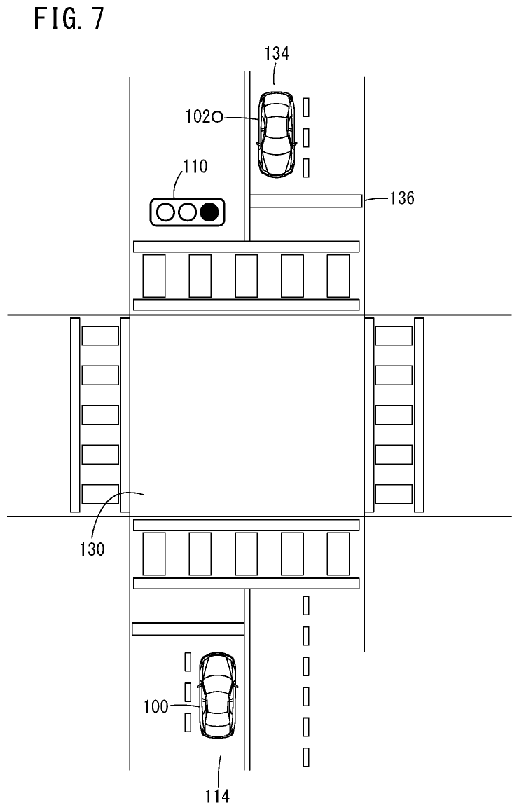

At step S6, the estimating unit 62 performs a signal estimation process. The estimating unit 62 estimates the traffic signal based on the traffic participants around the traffic signal device 110, e.g., the movement of forward vehicles 102F, a backward vehicle 102B, and sideward vehicle 102S shown in FIGS. 4 and 5, a crossing vehicle 102C and pedestrian H shown in FIG. 6, or an opposing vehicle 102O shown in FIG. 7. The details of the signal estimation process are described below in section [2.2].

At step S7, the comparing unit 64 compares the traffic signal recognized by the traffic signal recognition unit 60 to the traffic signal estimated by the estimating unit 62. If these signals match (step S7: MATCH), the process move to step S8. If these signals do not match (step S7: NO MATCH), the process moves to step S9.

If the process has moved from step S7 to step S8, the control unit 50 performs travel control based on the traffic signal recognized by the traffic signal recognition unit 60 (or the traffic signal estimated by the estimating unit 62). More specifically, the action plan unit 66 creates the action plan based on the traffic signal recognized by the traffic signal recognition unit 60. The trajectory generating unit 68 generates the scheduled travel trajectory in accordance with the action plan. The vehicle control unit 70 determines the vehicle control values based on the scheduled travel trajectory, and outputs control instructions corresponding to the vehicle control values to the drive force device 22, the steering device 24, and the braking device 26. If the traffic signal permits progress, the vehicle control unit 70 outputs control instructions causing the vehicle 100 to pass through the installation location of the traffic signal device 110. If the traffic signal prohibits progress, the vehicle control unit 70 outputs control instructions causing the vehicle 100 to stop at a stop position (stop line) of the traffic signal device 110 or to stop at a position a prescribed distance from a forward vehicle 102F.

If the process has moved from step S7 to step S9, the control unit 50 makes a T/O (Take Over) request, i.e. a request to take over the driving. Specifically, the action plan unit 66 determines that the reliability of the signal recognition by the external environment recognition unit 46 is low. The notification control unit 72 receives the determination made by the action plan unit 66, and outputs notification instructions for the T/O request to the notification device 28.

At step S10, the control unit 50 performs deceleration control. Specifically, the action plan unit 66 creates an action plan for decelerating and stopping. The trajectory generating unit 68 generates the scheduled travel trajectory in accordance with the action plan. The vehicle control unit 70 determines the vehicle control values based on the scheduled travel trajectory, and outputs control instructions corresponding to these vehicle control values to the drive force device 22, the steering device 24, and the braking device 26. The vehicle control unit 70 outputs control instructions for decelerating the vehicle 100 with a prescribed deceleration and stopping the vehicle 100.

At step S11, if the vehicle velocity Vo (value measured by the velocity sensor 40) is not 0, i.e., if the vehicle 100 is travelling (step S11: YES), the process moves to step S12. On the other hand, if the vehicle velocity Vo (value measured by the velocity sensor 40) is 0, i.e., if the vehicle 100 is stopped (step S11: NO), the process ends for now.

At step S12, the driving mode control unit 52 determines whether the driving takeover has been performed. When the driver manipulates the automated driving switch 16 or any manipulation device in response to the T/O request, the driving mode control unit 52 performs the transition process from the automated driving mode to the manual driving mode, and outputs a transition signal to the control unit 50. At this time, responsibility for driving the host vehicle 100 is transferred from the vehicle control system 10 to the driver. If a takeover of the driving responsibility has been performed (step S12: YES), the process ends for now. On the other hand, if a takeover of the driving responsibility has not been performed (step S12: NO), the process returns to step S9.

[2.2. Signal Estimation Process]

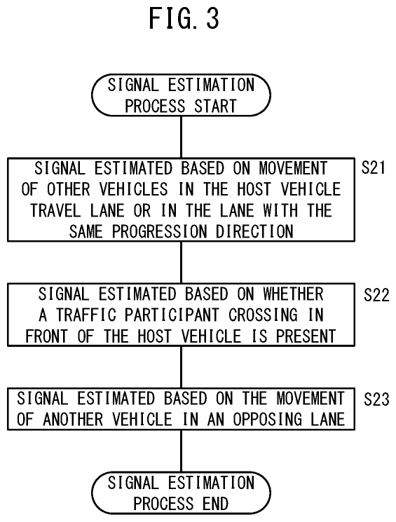

The following describes the signal estimation process performed in step S6 of FIG. 2, using FIG. 3. Each process below is performed by the estimating unit 62 of the traffic signal processing unit 48. The order of the processes of steps S21 to step S23 shown in FIG. 3 is not limited, and the order of these steps may be changed arbitrarily or these processes may be performed simultaneously.

The process of step S21 is described using FIGS. 4 and 5. In the embodiment example shown in FIGS. 4 and 5, a travel road 112a includes three lanes (a travel lane 114 and other lanes 116 and 118). The host vehicle 100 travels in the travel lane 114 that is the center lane. Furthermore, the forward vehicles 102F are present in front of the host vehicle 100, the backward vehicle 102B is present behind the vehicle 100, and sideward vehicles 102S are present at respective sides of the host vehicle 100. FIGS. 4 and 5 show a state where the host vehicle 100 is stopped.

At step S21, the estimating unit 62 estimates the traffic signal of the traffic signal device 110 based on the movement of the other vehicles (forward vehicles 102F, backward vehicle 102B, and sideward vehicles 102S) travelling in the travel lane 114 in which the host vehicle 100 is travelling or the other lanes 116 and 118 whose progression directions match that of the travel lane 114, among the lanes 114, 116, and 118 that are on the host vehicle 100 side of the traffic signal device 110. It is noted that the estimating unit 62 does not reference the movement of the other vehicles (the forward vehicles 102F and sideward vehicles 102S) that are travelling in the other lanes 116a and 118a whose progression directions do not match that of the travel lane 114, as shown in FIG. 5. At this time, the external environment recognition unit 46 recognizes the progression directions of the other lanes 116, 116a, 118, and 118a using the image information of the camera 30 or the map information 76.

The estimating unit 62 estimates the traffic signal of the traffic signal device 110 according to whether the other vehicles 102F stop in front of the traffic signal device 110, for example. If the travel position of the host vehicle 100 is within a prescribed region in front of the traffic signal device 110 and a braking manipulation of another vehicle 102F has been recognized by the traffic participant recognition unit 58, the estimating unit 62 estimates that the traffic signal of the traffic signal device 110 is a stop instruction signal. On the other hand, if the travel position of the host vehicle 100 is within a prescribed region in front of the traffic signal device 110 and a braking manipulation of another vehicle 102F has not been recognized by the traffic participant recognition unit 58, the estimating unit 62 estimates that the traffic signal of the traffic signal device 110 is a progression allowance signal. The traffic participant recognition unit 58 recognizes the braking manipulation of the other vehicle 102F based on the image information (lit state of the brake lights) of the camera 30 or the communication results of the communication device 38.

Alternatively, the estimating unit 62 may estimate the traffic signal of the traffic signal device 110 based on the relative velocities of the other vehicles 102F, 102B, and 102S calculated by the traffic participant recognition unit 58. If there are a plurality of other vehicles 102F, 102B, and 102S, the estimating unit 62 may estimate the relative velocities of the other vehicles 102F, 102B, and 102S at prescribed positions.

The following describes the process of step S22 using FIG. 6. In the embodiment example shown in FIG. 6, a road 120 and a crosswalk 122 intersect with the travel road 112 on which the host vehicle 100 is travelling. A crossing vehicle 102C travels on the road 120, and a pedestrian H crosses at the crosswalk 122. FIG. 6 shows a state where the host vehicle 100 is stopped.

At step S22, the estimating unit 62 estimates the traffic signal of the traffic signal device 110 based on whether the crossing vehicle 102C or the pedestrian H (referred to above as traffic participants) is present in front of the host vehicle 100. At this time, the traffic participant recognition unit 58 recognizes the crossing vehicle 102C using the image information of the camera 30. Specifically, the traffic participant recognition unit 58 recognizes, as the crossing vehicle 102C, a recognition target that is provided with wheels positioned at the same height.

If the crossing vehicle 102C or the pedestrian H crossing at the crosswalk 122 has been recognized by the traffic participant recognition unit 58, the estimating unit 62 estimates that the traffic signal of the traffic signal device 110 is the stop instruction signal. On the other hand, if the crossing vehicle 102C and pedestrian H are not detected for a prescribed time by the traffic participant recognition unit 58, the estimating unit 62 estimates that the traffic signal of the traffic signal device 110 is a progression allowance signal.

The following describes the process of step S23 using FIG. 7. In the embodiment example shown in FIG. 7, an opposing lane 134, in which the progression direction is opposite the progression direction in the travel lane 114, is adjacent to the travel lane 114 in which the host vehicle 100 is travelling. Furthermore, an opposing vehicle 102O is stopped at a stop position 136 of the opposing lane 134 that opposes the travel lane 114 across an intersection 130. FIG. 7 shows a state in which the host vehicle 100 is stopped.

At step S23, the estimating unit 62 estimates the traffic signal of the traffic signal device 110 based on the movement of the other vehicle (opposing vehicle 102O) in the opposing lane 134, as shown in FIG. 6. At this time, the external environment recognition unit 46 recognizes the opposing lane 134 and the stop position 136 therein, using the map information 76 or the image information obtained by the camera 30.

If the traffic participant recognition unit 58 recognizes that the opposing vehicle 102O is stopped at the stop position 136 of the traffic signal device 110, the estimating unit 62 estimates that the traffic signal of the traffic signal device 110 is the stop instruction signal. On the other hand, if the traffic participant recognition unit 58 does not recognize that the opposing vehicle 102O is stopped at the stop position 136 of the traffic signal device 110, the estimating unit 62 estimates that the traffic signal of the traffic signal device 110 is the progression allowance signal.

The estimating unit 62 estimates the traffic signal to be obeyed next by performing the processes of step S21 to step S23 described above. Instead, the estimating unit 62 may estimate the traffic signal by performing the process of one of steps S21 to S23. Furthermore, in a case where an estimation result of any one of step S21 to step S23 differs from the estimation result of the others, the estimating unit 62 may adopt the majority estimation result, or alternatively the estimating unit 62 may adopt the estimation result of the process given higher priority (e.g., the process of step S21) among the processes of step S21 to step S23. Yet further, in a case where the traffic signal cannot be estimated by any one of the processes of step S21 to step S23, this process is treated as not having an estimation result.

[2.3. Summary of the First Embodiment]

The control device 20 according to the present embodiment includes the traffic signal recognition unit 60 configured to recognize the traffic signal of the traffic signal device 110 to be obeyed next, based on the external environment information, the traffic participant recognition unit 58 configured to recognize movement of traffic participants, based on the external environment information, the estimating unit 62 configured to estimate the traffic signal to be obeyed next, based on the movement of the traffic participants recognized by the traffic participant recognition unit 58, the comparing unit 64 configured to compare the traffic signal recognized by the traffic signal recognition unit 60 to the traffic signal estimated by the estimating unit 62, and the control unit 50 configured to perform control based on the comparison result of the comparing unit 64. According to the above configuration, even when misidentification of a traffic signal occurs, it is possible to prevent control based on this misidentification, since prescribed control is performed using the result of the comparison between the recognized traffic signal and the estimated traffic signal.

As shown in FIGS. 4 and 5, the estimating unit 62 estimates the traffic signal based on the movement of the other vehicles (forward vehicles 102F, backward vehicle 102B, and sideward vehicles 102S) that are travelling in the travel lane 114 in which the vehicle 100 is travelling or in the other lanes 116 and 118 whose progression directions are the same as that of the travel lane 114, among the lanes on the host vehicle 100 side of the traffic signal device 110. Specifically, if the traffic participant recognition unit 58 recognizes that another vehicle has stopped in front of the traffic signal device 110, the estimating unit 62 estimates that the traffic signal is the stop instruction signal. According to the above configuration, it is possible to accurately estimate the traffic signal, by estimating the signal shown by the traffic signal device 110 based on the movement of the other vehicles that obey the same signal as the traffic signal to be obeyed by the host vehicle 100.

As shown in FIG. 6, if a traffic participant (crossing vehicle 102C or pedestrian H) crossing in front of the host vehicle 100 is recognized by the traffic participant recognition unit 58, the estimating unit 62 estimates that the traffic signal is the stop instruction signal. According to the above configuration, it is possible to accurately estimate the traffic signal, by estimating the signal shown by the traffic signal device 110 based on the movement of the other vehicles that obey a different signal than the traffic signal to be obeyed by the host vehicle 100.

As shown in FIG. 7, if the traffic participant recognition unit 58 recognizes that another vehicle, which is located in the opposing lane 134 that opposes the travel lane 114 in which the host vehicle 100 is travelling, has stopped at the stop position 136 of the traffic signal device 110, the estimating unit 62 estimates that the traffic signal is the stop instruction signal. According to the above configuration, it is possible to accurately estimate the traffic signal, by estimating the signal shown by the traffic signal device 110 based on the movement of the other vehicles that obey the same signal as the traffic signal to be obeyed by the host vehicle 100.

If the traffic signal recognized by the traffic signal recognition unit 60 differs from the traffic signal estimated by the estimating unit 62 (step S7 of FIG. 2: NO MATCH), the notification control unit 72 makes a request for manual driving to the driver (step S9 of FIG. 2). With the above configuration, it is possible for the driver to take over the driving when the device cannot determine which of the recognized traffic signal and the estimated traffic signal is correct.

If the traffic signal recognized by the traffic signal recognition unit 60 differs from the traffic signal estimated by the estimating unit 62 (step S7 of FIG. 2: NO MATCH), the vehicle control unit 70 decelerates or stops the host vehicle 100 (step S10 of FIG. 2). With the above configuration, it is possible to suitably control the host vehicle 100 even if the driver does not take over the driving.

Furthermore, the control method according to the present embodiment includes a traffic signal recognition step (step S4) of recognizing the traffic signal of the traffic signal device 110 to be obeyed next, based on the external environment information, a traffic participant recognizing step (step S5) of recognizing the movement of traffic participants, based on the external environment information, an estimation step (step S6) of estimating the traffic signal to be obeyed next, based on the movement of the traffic participants recognized in the traffic participant recognition step (step S5), a comparing step (step S7) of comparing the traffic signal recognized in the traffic signal recognition step (step S4) and the traffic signal estimated in the estimation step (step S6), and control steps (step S8 to step S12) for performing control based on the comparison result of the comparison step (step S7). According to the above configuration, even when misidentification of a traffic signal occurs, it is possible to prevent control based on this misidentification, by performing prescribed control using the result of the comparison between the recognized traffic signal and the estimated traffic signal.

### 3. Process Performed by the Control Device 20 According to the Second Embodiment

[3.1. Main Process]

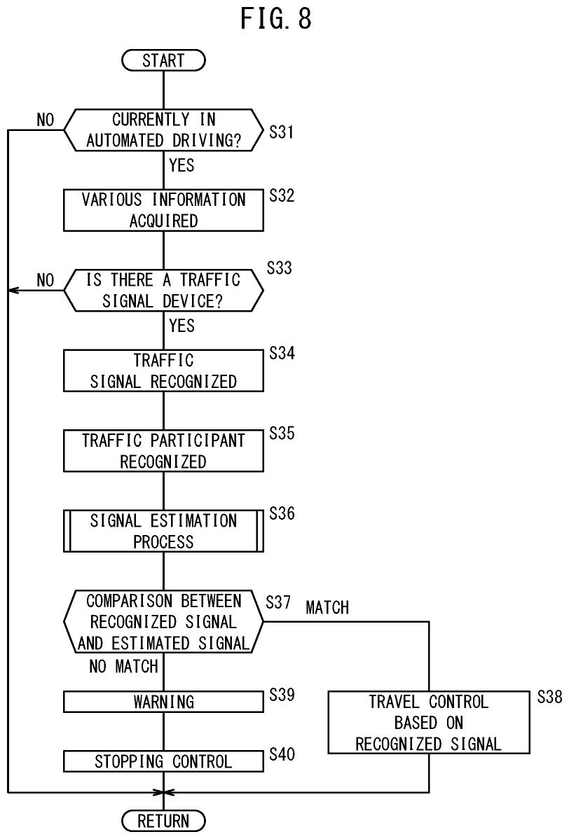

The following describes the main process performed by the control device 20, using FIG. 8. Among the processes described below, the processes of steps S31 to S38 are the same as the processes of step S1 to step S8 shown in FIG. 2, and therefore descriptions thereof are omitted.

If the process has moved from step S37 to step S39, the control unit 50 requests a warning. Specifically, the action plan unit 66 determines that the reliability of the signal recognition by the external environment recognition unit 46 is low. The notification control unit 72 receives this determination by the action plan unit 66, and outputs notification instructions for a warning to the notification device 28.

At step S40, the control unit 50 performs stopping control. Specifically, the action plan unit 66 creates an action plan for stopping. The trajectory generating unit 68 generates the scheduled travel trajectory in accordance with the action plan. The vehicle control unit 70 determines the vehicle control values based on the scheduled travel trajectory, and outputs control instructions corresponding to these vehicle control values to the drive force device 22, the steering device 24, and the braking device 26. The vehicle control unit 70 outputs control instructions for stopping the vehicle 100.

[3.2. Summary of the Second Embodiment]

If the traffic signal recognized by the traffic signal recognition unit 60 differs from the traffic signal estimated by the estimating unit 62 (step S37 of FIG. 8: NO MATCH), the notification control unit 72 provides a warning to the driver (step S39 of FIG. 8: NO MATCH). With the above configuration, the driver can be notified that the device cannot determine which of the recognized traffic signal and the estimated traffic signal is correct.

The control device 20 and the control method according to the present invention are not limited to the embodiments described above, and it goes without saying that various modifications could be adopted therein without departing from the essence and gist of the present invention.

1. A control device that performs prescribed control of a host vehicle using external environment information acquired by an external environment sensor, the control device comprising:
a traffic signal recognition unit configured to recognize a traffic signal of a traffic signal device to be obeyed next, based on the external environment information;
a traffic participant recognition unit configured to recognize movement of a traffic participant, based on the external environment information;
an estimating unit configured to estimate the traffic signal to be obeyed next, based on the movement of the traffic participant recognized by the traffic participant recognition unit;
a comparing unit configured to compare the traffic signal recognized by the traffic signal recognition unit to the traffic signal estimated by the estimating unit; and
a control unit configured to perform the control based on a comparison result of the comparing unit.

2. The control device according to claim 1, wherein
the estimating unit estimates the traffic signal based on movement of another vehicle travelling in a travel lane in which the host vehicle is travelling or in another lane that has a same progression direction as the travel lane.

3. The control device according to claim 2, wherein
if the traffic participant recognition unit recognizes that the other vehicle has stopped in front of the traffic signal device, the estimating unit estimates that the traffic signal is a stop instruction signal.

4. The control device according to claim 1, wherein
if the traffic participant recognition unit recognizes a traffic participant that is crossing in front of the host vehicle, the estimating unit estimates that the traffic signal is a stop instruction signal.

5. The control device according to claim 1, wherein
if the traffic participant recognition unit recognizes that another vehicle located in an opposing lane that opposes a travel lane in which the host vehicle is travelling has stopped at a stop position of the traffic signal device, the estimating unit estimates that the traffic signal is a stop instruction signal.

6. The control device according to claim 1, wherein
if the traffic signal recognized by the traffic signal recognition unit differs from the traffic signal estimated by the estimating unit, the control unit makes a request for manual driving to a driver.

7. The control device according to claim 1, wherein
if the traffic signal recognized by the traffic signal recognition unit differs from the traffic signal estimated by the estimating unit, the control unit decelerates or stops the host vehicle.

8. The control device according to claim 1, wherein
if the traffic signal recognized by the traffic signal recognition unit differs from the traffic signal estimated by the estimating unit, the control unit provides a warning to a driver.

9. A control method for performing prescribed control of a host vehicle using external environment information acquired by an external environment sensor, the control method comprising:
a traffic signal recognizing step of recognizing a traffic signal of a traffic signal device to be obeyed next, based on the external environment information;
a traffic participant recognizing step of recognizing movement of a traffic participant, based on the external environment information;
an estimating step of estimating the traffic signal to be obeyed next, based on the movement of the traffic participant recognized in the traffic participant recognizing step;
a comparing step of comparing the traffic signal recognized in the traffic signal recognizing step to the traffic signal estimated in the estimating step; and
a control step of performing the control based on a comparison result of the comparing step.
